(19) United States
(12) Patent Application Publication
(10) Pub. No.: US 2026/0316746 A1
(43) Pub. Date: Oct. 15, 2026

(54) HYBRID-ELECTRIC POWERTRAIN ASSEMBLY FOR A WORK VEHICLE AND CONTROL METHOD THEREOF

(71) Applicant: CNH INDUSTRIAL ITALIA S.P.A., Turin (IT)

(72) Inventors: ALBERTO BORGHI, Carpineti (IT); NICHOLAS ZANASI, Modena (IT); ALESSIO INVERSANI, Cavezzo (IT); MICHELANTONIO FORTE, Turin (IT); STEFANO GRECO LUCCHINO, RUBIERA (IT)

(73) Assignee: CNH INDUSTRIAL ITALIA S.P.A., Turin (IT)

(21) Appl. No.: 19/645,989

(22) Filed: Apr. 13, 2026

(30) Foreign Application Priority Data
Apr. 14, 2025 (IT) 102025000008247

(51) Int. Cl. B60W 20/30; B60W 10/02; B60W 10/08; B60W 10/111

(52) U.S. Cl. CPC B60W 20/30; B60W 10/02; B60W 10/08; B60W 10/111; B60W 2510/1005; B60W 2710/021; B60W 2710/083; B60W 2710/105

(57) ABSTRACT

A method for controlling a hybrid drivetrain assembly of a work vehicle includes i) transmitting a torque to at least one drive axle of the work vehicle via a first speed ratio; ii) receiving a request to shift from a first speed gear ratio to a second speed gear ratio, the second speed gear ratio being different from the first speed ratio; iii) disengaging a clutch that is transmitting torque towards an output shaft and controlling a second electric machine to provide the torque to the at least one drive axle of the work vehicle, and iv) start engaging the clutch operatively connected to the second speed gear ratio and at a same time decreasing a torque provided by the second electric machine until the torque provided to the at least one drive axle is provided through a second clutch.

### CROSS-REFERENCE TO RELATED APPLICATION

The present disclosure is based upon and claims priority to Italian patent application IT 102025000008247 filed on Apr. 14, 2025. The entire disclosure of the Italian patent application, including specifications, drawings, and claims are incorporated herein by reference in their entirety.

### TECHNICAL FIELD

The present disclosure relates generally to a hybrid-electric powertrain assembly for a work vehicle and, in particular, to an agricultural vehicle such as a tractor, and the control method thereof.

The present inventive concepts may be applied in a hybrid-electric powershift powertrain assembly for a tractor or other similar agricultural vehicle. Reference will be made to the present inventive concepts by way of the various example embodiments described below.

### BACKGROUND

Transmissions for work vehicles such as agricultural vehicles may be provided with different configurations, such as, for example: i) manual shifted transmissions, in which all gears of the transmissions are engaged directly by the driver through lever mechanisms that command clutches, synchronizers, and dog clutches to select the gear; ii) semi-power shift transmission, in which some gears are engaged in power shift mode, i.e., by swapping the torque by a couple of clutches, and other gears are actuated like in manual shifted transmissions; iii) full power shift transmission, in which all gears of the transmission are engaged in power shift mode, and iv) continuous variable transmissions (CVT), in which the transmission ratio is varied in a continuous and seamless manner.

As may be known in the art, a great advantage of manual shifted, semi powershift and full powershift transmission is great efficiency, since the torque is transmitted by means of transmission shafts and gears mechanically engaged to each other.

However, the shifting between gears entails an interruption of the torque transmission for a predetermined time. Such interruption clearly leads to a deceleration of the vehicle and furthermore causes jerks that reduce the comfort of the driver.

On the other hand, in continuous variable transmissions (CVT), the transmission ratio is varied in a seamless manner throughout the entire transmission range of the vehicle. This clearly improves the comfort and the user experience of the driver.

A common configuration of such continuous variable transmissions is hydro-mechanical power split transmission, provided with two parallel torque-transferring paths, such as, for example, a mechanical path provided with a stepped transmission, and a hydrostatic path provided with a hydrostatic transmission comprising a hydrostatic pump driven by the internal combustion engine and a hydrostatic motor.

Such hydro-mechanical power split transmissions further comprise a planetary gear train coupling the mechanical path and the hydrostatic path.

Unfortunately, due to the double conversion of the energy between mechanical to hydraulic performed by the hydrostatic pump and then hydraulic to mechanical performed by the hydrostatic motor, the efficiency of such hydro-mechanical power split transmission is limited, with the obvious drawbacks that this entails.

Therefore, the need is felt for improvements in (or it may be beneficial to improve) the field of vehicular transmissions, in particular, by providing a powertrain assembly with improved efficiency and user experience.

The present disclosure is directed to overcoming one or more of the above-mentioned challenges in a cost-effective and optimized manner.

### SUMMARY

The inventive concepts described in the present disclosure are related to a powertrain assembly and a method for controlling a hybrid drivetrain assembly, as claimed in the appended set of claims.

Some embodiments provide a method for controlling a hybrid drivetrain assembly of a work vehicle, including: i) transmitting a torque to at least one drive axle of the work vehicle via a first speed ratio; ii) receiving a request to shift from a first speed gear ratio to a second speed gear ratio, the second speed gear ratio being different from the first speed ratio; iii) disengaging a clutch that is transmitting torque towards an output shaft and controlling a second electric machine to provide the torque to the at least one drive axle of the work vehicle, and iv) start engaging the clutch operatively connected to the second speed gear ratio and at a same time decreasing a torque provided by the second electric machine until the torque provided to the at least one drive axle is provided through a second clutch.

Some example embodiments provide a hybrid drivetrain assembly of a work vehicle, including mechanical transmission, an electronic control unit, and an electric transmission. The mechanical transmission includes an input shaft connected to an internal combustion engine, an output shaft connected to the at least one drive axle of the work vehicle, a gear ratio stage and a range gear ratio stage arranged in series to each other between the input shaft and the output shaft, and an intermediate shaft interposed between the gear ratio stage and the range gear ratio stage. The electric transmission includes, a first electric machine adapted to be carried by the internal combustion engine to receive mechanical energy provided the first electric machine and transform the mechanical energy into electrical energy, a second electric machine adapted to be connected to a drive axle of the work vehicle to impart a torque to the drive axle, an electric power management device electrically connected to the first electric machine and the second electric machine, and an electric energy storage system electrically connected to the first electric machine and to the second electric machine. The electronic control unit is configured to control operation of the hybrid drivetrain assembly to cause the hybrid drivetrain assembly to: i) transmit a torque to at least one drive axle of a work vehicle via a first speed ratio; ii) receive a request to shift from a first speed gear ratio to a second speed gear ratio, the second speed gear ratio being different from the first speed ratio; iii) disengage a clutch that is transmitting torque towards an output shaft and controlling a second electric machine to provide the torque to the at least one drive axle of the work vehicle, and iv) start engaging the clutch operatively connected to the second speed gear ratio and at a same time decreasing a torque provided by the second electric machine until the torque provided to the at least one drive axle is provided through a second clutch.

This summary is illustrative only and is not intended to be in any way limiting. Other aspects, features, and advantages of the devices or processes described herein will become apparent in the detailed description set forth herein, taken in conjunction with the accompanying figures.

### BRIEF DESCRIPTION OF DRAWINGS

Some embodiments of inventive concepts are best understood with reference to the accompanying figures, in which:

FIG. 1 is a schematic representation of the architecture of a work vehicle comprising a powertrain assembly according to some embodiments, with parts removed for clarity,

FIG. 2 is the schematic representation, with increased detail, of the powertrain assembly represented in FIG. 1, with parts removed for clarity.

### DETAILED DESCRIPTION

Some example embodiments will now be described with reference to the drawings. The detailed description does not limit the scope of the present inventive concepts, which are defined by the appended claims.

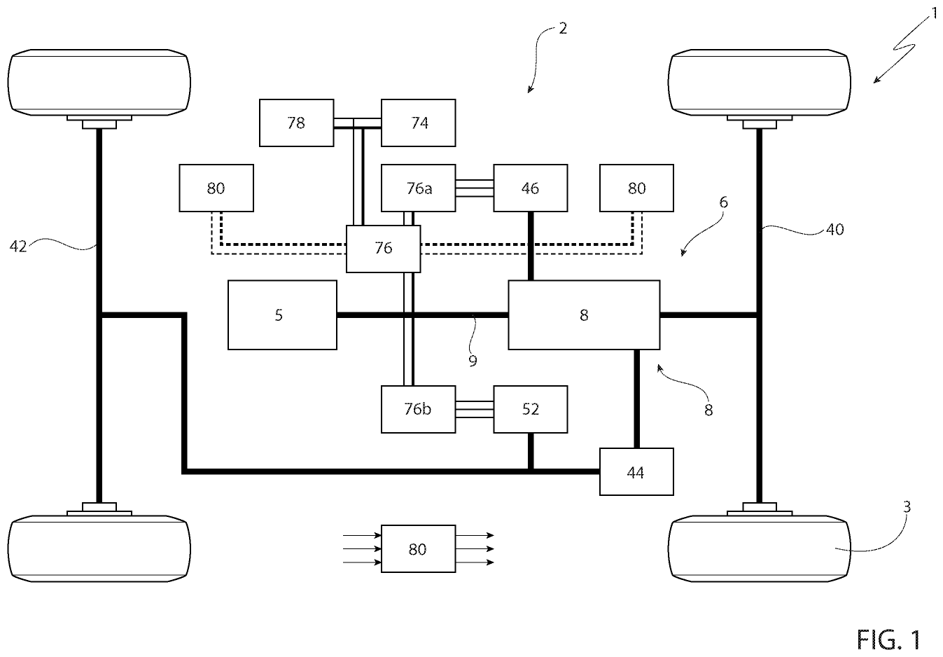

With reference to FIG. 1, number 1 schematically denotes, as a whole, a work vehicle, in particular, an agricultural vehicle such as a tractor, but example embodiments are not limited thereto. For example, the work vehicle could be any other agricultural vehicle.

Work vehicle 1 comprises a powertrain assembly 2 configured to provide torque to ground resting means 3, such as wheels and/or tracks, to allow motion of the work vehicle 1 on the ground. As described herein, the ground resting means may also be referred to as the wheels 3, including the rear wheels 3, and/or the front wheels 3.

Powertrain assembly 2 comprises an internal combustion engine 5, for example, a diesel powered, or a methane powered internal combustion engine.

As explained more in detail in the following, powertrain assembly 2 has a hybrid-electric configuration, in particular, a power-split hybrid-electric configuration, including, for example, a parallel hybrid-electric configuration.

In addition, powertrain assembly 2 comprises a drivetrain assembly 6 operatively interposed between internal combustion engine 5 and an output shaft 4 preferably connected to at least one drive axle of work vehicle 1 and the wheels 3, in order to transmit to the wheels 3 the torque provided by internal combustion engine 5.

For example, output shaft 4 may be connected to the rear drive axle 40 of work vehicle 1 to drive the rear wheels 3.

In addition, output shaft 4 may be selectively connectable to a front drive axle 42 of work vehicle 1, to drive the front wheels 3.

More in detail, drivetrain assembly 6 may comprise a clutch 44 operatively interposed between output shaft 4 and front drive axle 42 and configured to selectively connect the front drive axle 42.

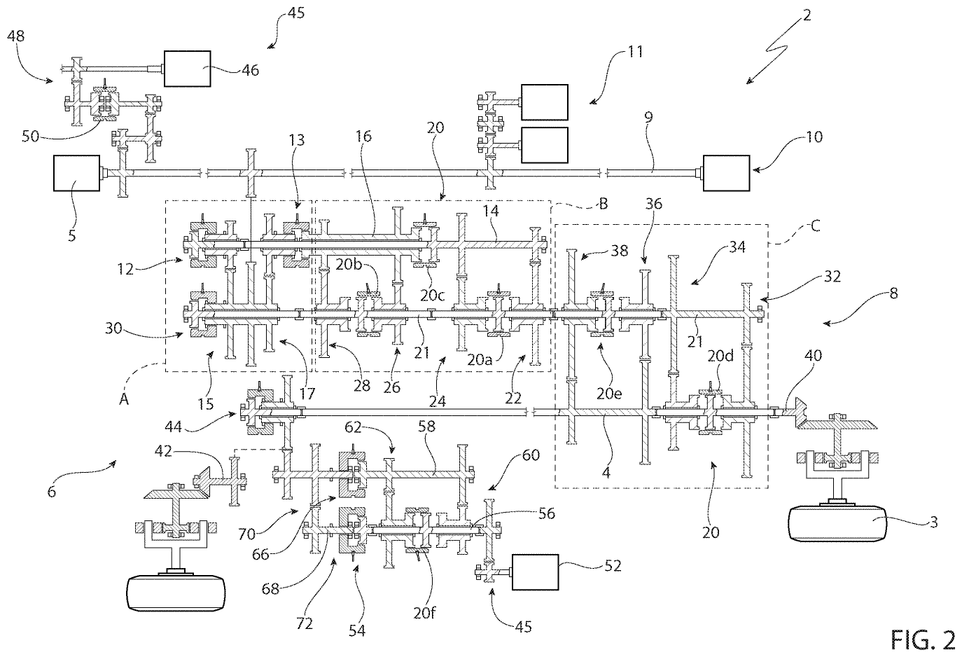

With reference to the exemplary embodiment illustrated in FIGS. 1 and 2, drivetrain assembly 5 comprises a mechanical portion or mechanical transmission 8 interposed between internal combustion engine 5 and the wheels 3.

As shown in FIG. 2, internal combustion engine 5 is advantageously connected to an input shaft 9 of the transmission 8 via a damper (not shown) interposed between an output shaft of internal combustion engine 5 and the input shaft 9 of the transmission 8. The input shaft 9 passes through transmission 8 to be used by other elements of the vehicle, such as a power take off module 10, hydraulic utilities 11, and/or the like.

With reference to FIG. 2, transmission 8 is preferably a mechanical stepped transmission, with a plurality of different gear ratios selectively engageable.

More in detail, transmission 8 is preferably a semi power-shift transmission, for example, a dual-clutch or a multi-clutch semi power-shift transmission, but example embodiments are not limited thereto.

Transmission 8 preferably comprises, in series one with respect to the other, an input stage A, a gear ratio stage B, and a range gear ratio stage C.

Input stage A may be realized in different manner to provide torque to a forward clutch (not illustrated) and in a reversed direction to a rearward clutch (not illustrated), both of which may be carried by the transmission input shaft 9. As it may be known in the art, and therefore not described in detail, forward clutch and rearward clutch selectively couple the internal combustion engine 5 with output shaft 4, in order to allow respectively forward and rearward motion of work vehicle 1.

In addition, input stage A is preferably made as a power-shift, and it preferably comprises a first clutch 12, hereinafter “even clutch 12”, and a second clutch 13, hereinafter “odd clutch 13”.

Even clutch 12 is configured to couple a first auxiliary shaft 14, hereinafter “even shaft 14”, with input shaft 9, preferably by a gearing 15.

Odd clutch 13 is configured to couple a second auxiliary shaft 16, hereinafter “odd shaft 16” with input shaft 9, preferably by a gearing 17.

Even clutch 12 and odd clutch 13 are selectively actuated by respective actuators.

With reference to the example illustrated in FIG. 2, even shaft 14 and odd shaft 16 preferably comprise each a plurality of selection elements, e.g., double synchronizers, dog clutches or joint clutches 20, carried by the respective shafts 14, 16.

Preferably, transmission 8 further comprises an intermediate shaft 21 operatively interposed between gear ratio stage B and a range gear ratio stage C.

In addition, gear ratio stage B preferably comprises a plurality of gears operatively interposed between the even shaft 14 and intermediate shaft 21, or the odd shaft 16 and intermediate shaft 21 and the plurality of gears are configured to define different transmission ratios relative to each other.

For example, gear ratio stage B may comprise four different gears.

With reference to the exemplary embodiment illustrated in FIG. 2, gear ratio stage B may comprise a gear 22 and a gear 24 interposed between even shaft 14 and intermediate shaft 21.

Gears 22 and 24 may comprise each a first toothed wheel fixedly carried by even shaft 14 and a second toothed wheel carried in a free rotatable manner by intermediate shaft 21 and engaging with the respective first toothed wheel.

Selections elements 20 may comprise a selection element 20a, in particular, a dog clutch carried by intermediate shaft 21 and configured to selectively couple the second toothed wheel of gear 22 or 24 with intermediate shaft 21.

In addition, gear ratio stage B may further comprise a gear 26 and a gear 28 interposed between even shaft 14 and intermediate shaft 21.

Gears 26 and 28 may comprise each a first toothed wheel fixedly carried by odd shaft 16 and a second toothed wheel carried in a free rotatable manner by intermediate shaft 21 and engaging with the respective first toothed wheel.

Selections elements 20 may comprise selection element 20b, in particular, a dog clutch, carried by intermediate shaft 21 and configured to selectively couple the second toothed wheel of gear 26 or 28 with intermediate shaft 21.

With reference to the example illustrated in FIG. 2, odd shaft 16 is preferably carried in a free rotatable manner by even shaft 14. More in detail, odd shaft 16 is preferably fitted in a free rotatable manner on even shaft 14.

Selection elements 20 may further comprise a selection element 20c, in particular, a dog clutch, operatively interposed between even shaft 14 and odd shaft 16 and configured to selectively couple even shaft 14 with odd shaft 16, thereby allowing to double the number of resulting transmission ratio obtainable.

As illustrated in FIG. 2, gear ratio stage B preferably further comprises a jump clutch 30, which is configured to couple the intermediate shaft 21 with input shaft 9, to provide an additional gear ratio between input shaft 9 and output saft 4.

With reference to the exemplary embodiment illustrated in FIG. 2, range gear ratio stage C is preferably configured to couple intermediate shaft 21 with output shaft 4 by choosing between a plurality of gear ratios, which are multiplied by the above-described gear ratios of the gear ratio stage B.

More in detail, range gear ratio stage C preferably comprises four range gears having different gear ratios and configured to be selectively coupled to output shaft 4 shaft by the respective dog clutches 20.

In this way, the transmission 1 of the provided exemplary embodiment may provide up to thirty-six possible gear ratios, due to the nine gear ratios repeated over the four range ratios, but example embodiments are not limited thereto.

With reference to the exemplary embodiment illustrated in FIG. 2, range gear ratio C preferably comprises four range gears 32 (e.g., slow range), 34 (e.g., medium II range), 36 (e.g., medium I range) and 38 (e.g., fast range) operatively interposed between intermediate shaft 21 and output shaft 4.

In the illustrated example, gears 32 and 34 may comprise each a first toothed wheel fixedly carried by intermediate shaft 21 and a second toothed wheel carried in a free rotatable manner by output shaft 4 and engaging with the respective first toothed wheel.

Selections elements 20 may comprise a selection element 20d, in particular, a dog clutch, carried by output shaft 4 and configured to selectively couple the second toothed wheel of gear 32 or 34 with the same output shaft 4.

Vice-versa, gears 36 and 38 may comprise each a first toothed wheel carried in a free rotatable manner by intermediate shaft 21 and a second toothed wheel fixedly carried by output shaft 4 and engaging with the respective first toothed wheel.

Selections elements 20 may comprise a selection element 20e, in particular, a dog clutch, carried by intermediate shaft 21 and configured to selectively couple the first toothed wheel of gear 36 or 38 with the same intermediate shaft 21.

According to some example embodiments, drivetrain assembly 6 comprises an electric portion or electric transmission 45. Electric transmission 45 is preferably configured to be arranged in parallel to transmission 8, and is preferably configured to be operatively interposed between internal combustion engine 5 and ground resting means 3.

In particular, electric transmission 45 is preferably configured to be coupled to rear drive axle 40 and/or to front drive axle 42.

In the illustrated example, electric transmission 45 is operatively coupled to front drive axle 42.

Electric transmission 45 preferably comprises a first electric machine 46 carried by internal combustion engine 5. More in detail, first electric machine 46 is preferably connected to internal combustion engine 5 by the transmission 48 and is preferably configured to operate as an electric generator, transforming the mechanical energy provided by internal combustion engine 5 into electric energy.

Transmission 48 preferably comprises a clutch 50 configured to selectively connect first electric machine 46 to internal combustion engine 5.

In addition, electric transmission 45 comprises a second electric machine 48, which is electrically connected to first electric machine 46 and is mechanically connected to a drive axle of work vehicle.

More in detail, second electric machine 48 is preferably connected to front drive axle 42.

In addition or alternative, second electric machine 48 may be connected to rear drive axle 40.

Second electric machine 48 may operate as an electric motor, to provide torque to the wheels 3, or it may operate as an electric generator, absorbing mechanical energy and producing electric energy for a later use, for instance, during work vehicle deceleration and/or braking or during the deceleration of an implement connected to work vehicle 1.

With reference to the exemplary embodiment illustrated in FIG. 2, second electric machine 48 is preferably connected to the drive axle of work vehicle 1 by a transmission assembly 54 configured to provide a plurality of different gear ratios selectively engageable.

More in detail, transmission assembly 54 is preferably configured to define three different gear ratios, namely a slow gear ratio, a medium gear ratio, and a fast gear ratio, but example embodiments are not limited thereto.

With reference to the exemplary embodiment illustrated in FIG. 2, transmission assembly 54 preferably comprises a first auxiliary shaft 56 connected to second electric machine 52, a second auxiliary shaft 58 configured to be connected to the drive axle of work vehicle 1, in particular, the front drive axle 42, a plurality of gears interposed between first 56 and second auxiliary shaft 58, and selection elements (e.g., a selector) configured to selectively engage one of said gears.

More in detail, transmission assembly 54 preferably comprises at least a first gear 60 and a second gear 62.

First gear 60 and second gear 62 preferably comprises each a first toothed wheel carried in a free rotatable manner by first auxiliary shaft 56 and a second toothed wheel fixedly carried by second auxiliary shaft 58 and engaging with the respective first toothed wheel.

In addition, selection elements 20 may comprise a selection element 20f, in particular, a dog clutch, carried by first auxiliary shaft 56 and configured to selectively couple the second toothed wheel of gear 60 or 62 with first auxiliary shaft 56.

Preferably, transmission assembly 54 further comprises a clutch 66 operatively interposed between second auxiliary shaft 58 and the drive axle of work vehicle 1, in particular, to front drive axle 42, to selectively couple second auxiliary shaft to this latter.

With reference to the exemplary embodiment illustrated in FIG. 2, transmission assembly 54 preferably comprises a third auxiliary shaft 68, which is connected to the drive axle of work vehicle 1, in particular, to front drive axle 42 by a gear 70 configured to define a different transmission ratio with respect to gears 60 and 62.

In addition, transmission assembly 54 further comprises a clutch 72 operatively interposed between first auxiliary shaft 56 and third auxiliary shaft 68, to selectively couple these latter.

As may be known in the art, and therefore not described in detail, clutches 12, 13, 30, 44, 66 and/or 68 may be actuated by respective actuators, for example, hydraulic actuator controlled by electronically controlled valves.

Similarly, selection elements 20 may be actuated by respective actuators, for example, hydraulic actuator controlled by electronically controlled valves.

According to some example embodiments, electric transmission 45 preferably comprises an electric energy storage system 74, in the following referred to also as “accumulator 74”, that is electrically connected to first electric machine 46 and second electric machine 52.

Preferably, the accumulator 74 comprise a battery pack, for example, a lithium-ion battery pack.

Accumulator 74 is configured to store the electric energy provided by first electric machine 46, second electric machine 52, and/or an external power grid.

In addition, electric portion preferably comprises a power management device 6, in the following referred to also as power distribution unit or PDU 76, that is electrically connected to the accumulator 74 and to first electric machine 46 and to second electric machine 52, and are configured to manage the electric energy transfer among them.

Preferably, the connection of PDU 76 with first electric machine 46 and second electric machine 52 is realized via inverters 76a and 76b that are operatively connected respectively to first electric machines 46 and to second electric machine 52.

With reference to the exemplary embodiment illustrated in FIG. 1, PDU 76 preferably comprises also an energy converter 78, in particular, a DC/DC energy converter electrically connected to accumulator 74 and configured to convert the voltage levels to and from the accumulator 74.

Preferably, electric portion 45 may further comprise one or more electric connectors 80 that allows to electrically connect the PDU 76 and the accumulator 74 to external electrical utilities, such as an external power grid, an external electrically powered implement or the like. Electric connectors 80 may be realized, for example, according to standard ISO 11783 (AEF connectors).

Work vehicle 1 further comprises an electronic control unit 80, which is configured to be electrically connected to the aforementioned actuators of clutches 12, 13, 30, 44, 66 and/or 68 and selection elements 20, to internal combustion engine 5, to PDU 76, and/or to inverters 76a and 76b. The electronic control unit 80 is configured to control their operation according to the control method described in the following.

Such control method, for instance, may be deployed into a specific computer program (e.g., software), which can be downloaded into the electronic control unit 80 and is configured to be executed by such electronic control unit 80.

More in detail, electronic control unit 80 may comprise one or more memories, one or more processing circuitries, and/or one or more processors. The one or more memories may be and/or include any tangible, non-transitory, computer-readable medium having stored thereon a computer program including instructions (e.g., software code including instructions) which, when executed by the one or more processors, causes the electronic control unit 80 to carry out the control method as described in the following.

The one or more processors, circuitries, and/or memories may include hardware including logic circuits, a hardware/software combination, or a combination thereof. For example, the one or more processors, circuitries, and/or memories may include, but are not limited to, a central processing unit (CPU), an arithmetic logic unit (ALU), a digital signal processor, a microprocessor, a field programmable gate array (FGPA), a System-on-Chip (SoC), a programmable logic unit, a microcomputer, application—specific integrated circuit (ASIC), and the like.

Electronic control unit 80 can be either the ECU of the work vehicle 1 or the ECU of drivetrain assembly 6.

The operation of the above-described hybrid-electric drivetrain 6 is the following.

During a standard driving condition of work vehicle 1, supposing that the first gear ratio and the slow range gear ratio are engaged, internal combustion engine 5 provides torque to input shaft 9 that passes via even clutch 12 to even shaft 14 and via gear 22 towards intermediate shaft 21 and then via gear 32 to output shaft 40. In such driving condition, selections elements 20a and 20d are controlled to respectively engage gears 22 and 32.

Supposing that the user wants to switch from the first gear ratio to the second gear ratio, i.e., to engage gear 28, starting from the above condition, then the electronic control unit will control the elements of the drivetrain assembly 6 1 as follows.

In a first phase, the even clutch 12 is disengaged and the second electric machine 52 is controlled to provide the torque that was transmitted to the driving axle of work vehicle 1. In the present disclosure, the terms “phase,” “operations,” and “steps” may be used interchangeably.

More in detail, during the first phase, even clutch 12 is disengaged, for instance progressively, and the torque provided to output shaft 4 by mechanical transmission 8 decreases and at the same time second electric machine 52 is controlled to increase its output torque, such that the torque transmitted to the drive axles of work vehicle 1 remains constant.

In particular, second electric machine 52 increases, e.g., in a smooth way, with an appropriate control strategy (e.g., linearly), the torque provided to the drive axle till reaching the value of torque that will be provided by the second gear ratio, if engaged.

Therefore, during such transient phase, there is no torque transmission by mechanical transmission 8 and torque is provided to the ground resting wheels 3 by the electric transmission 40.

More in detail, second electric machine 46 may be controlled in order to maintain constant the acceleration of work vehicle 1, to avoid jerks when even clutch 12 is disengaged.

In other words, during such transient phase, second electric machine 46 may be controlled in order to maintain constant the torque applied to ground resting wheels 3.

Optionally, during such transient phase, if no sufficient energy is present in the accumulator 74 or as predefined option to not discharge this latter (e.g., the accumulator 74), the internal combustion engine 5 may increase its speed to allow first electric machine 46 to provide energy to second electric machine 52 to achieve its function.

Preferably, selection element 20d is further configured to couple gear 28 with intermediate shaft 21.

Then, in a second phase, second electric machine 52 decreases its output torque while odd clutch 13 is engaged in a smooth via, e.g., a linear slope, thereby passing again to a mechanical transmission of all torque from internal combustion engine 13 to output shaft 4. In such condition, the second electric machine 52 is controlled according to the control law of clutch engagement to maintain constant the acceleration of work vehicle 1.

According to the above operation, a method of controlling a hybrid drivetrain 6 as described above and comprising the following phases (or steps, or operations):
i) Controlling internal combustion engine 5 to provide a level of torque T1 to ground resting means 3 via a first gear ratio,
ii) Receiving a request to shift from the first gear ratio to a second gear ratio;
iii) Disengage the clutch that is transmitting torque towards the output shaft 4 and controlling second electric machine 52 to provide the torque level T1 to ground resting means 3, and
iv) Start engaging the second clutch connected to the second gear ratio and at the same time decreasing the torque provided by the second electric machine 52 till all the torque provided to output shaft 4 is provided through the second clutch.

Preferably, step iv) further comprises to control internal combustion engine 5 in order to provide at output the torque level T1 when the second clutch is engaged.

More in detail, step iv) comprises the step of progressively engage the second clutch and simultaneously reduce the output torque provided by second electric machine 52, in order to maintain constant the torque provided to the ground resting wheels 3 during the shift between two gear ratios.

Preferably, the method may further comprise the step of controlling inverter 76a in order to absorb mechanical power from internal combustion engine 5 to allow first electric machine 46 to generate electric energy.

Preferably, during phases iii) and iv), the torque transmitted by second electric machine 52 and internal combustion engine 5 to ground resting wheels 3 is controlled to maintain constant the acceleration of work vehicle 1.

In view of the foregoing, the advantages of a hybrid drivetrain provided with an apparatus configured to carry out the method according to the present inventive concepts are apparent.

Thanks to the proposed method, it is possible to shift between different gear ratios maintaining constant the torque provided to the ground resting wheels 3, thereby avoiding jerks and increasing the driver's comfort.

In particular, according to the proposed method, it is possible to accelerate and shift between different gear ratios in a smooth and seamless manner, without torque transmission interruption at the wheels 3 during the shift between two different gear ratios. This replicates (or emulates, or provides) the behavior and the user experience of a CVT, with all the benefits that this entails.

In addition, since in most of the operation conditions, in particular, during steady state operation condition, all the torque is transmitted to the wheels 3 via the mechanical transmission 8, it is possible to maximize (or increase) the efficiency of the drivetrain assembly 6.

Moreover, since second electric machine 52 is connected to the front wheels 3, it is possible to reduce the turning radius of work vehicle 1. This improves (or greatly improves) the maneuverability and the user experience of the same work vehicle, in particular when it is necessary to perform a U-turn, for example, at the end of a field during a plowing or seeding operation.

In addition, the proposed arrangement improves controllability in slippery conditions, since it is possible to control in a very precise manner the torque provided at output by second electric machine 52.

Since in the proposed arrangement, the first electric machine 46 is connected to internal combustion engine 5, in case the state of charge of accumulator 74 is low, first electric machine 46 can absorb mechanical energy from internal combustion engine 5 to provide electric energy to the same accumulator 74 or to second electric machine 52. This allows (or enables) to be able (or always be able) to perform a return to home functionality, e.g., to avoid risks of remaining stranded due to lack of electric energy in the accumulator 74.

It is clear that modifications can be made to the described apparatus and method which do not extend beyond the scope of protection defined by the claims.

For example, the provided gear ratio stage B and range gear ratio stage C may comprise a different number of gear wheels. Moreover, further shafts or clutches may be present.

1. A method for controlling a hybrid drivetrain assembly of a work vehicle, the method comprising:
i) transmitting a torque to at least one drive axle of the work vehicle via a first speed ratio,
ii) receiving a request to shift from a first speed gear ratio to a second speed gear ratio, the second speed gear ratio being different from the first speed ratio;
iii) disengaging a clutch that is transmitting torque towards an output shaft and controlling a second electric machine to provide the torque to the at least one drive axle of the work vehicle, and
iv) start engaging the clutch operatively connected to the second speed gear ratio and at a same time decreasing a torque provided by the second electric machine until the torque provided to the at least one drive axle is provided through a second clutch,
wherein the hybrid drivetrain assembly comprises a mechanical transmission including,
an input shaft connected to an internal combustion engine,
an output shaft connected to the at least one drive axle of the work vehicle,
a gear ratio stage and a range gear ratio stage arranged in series to each other between the input shaft and the output shaft, and
an intermediate shaft interposed between the gear ratio stage and the range gear ratio stage,
wherein the gear ratio stage includes,
a first shaft,
a first set of gears connecting the first shaft with the intermediate shaft and defining a plurality of different speed ratios,
a first selection element configured to selectively connect one gear of the first set of gears with the first shaft or the intermediate shaft,
a first clutch configured to selectively connect the first shaft with the input shaft,
a second shaft,
a second set of gears connecting the second shaft with the intermediate shaft defining a plurality of different speed ratios,
a second selection element configured to selectively connect one gear of the second set of gears with the second shaft or the intermediate shaft, wherein the second clutch is configured to selectively connect the second shaft with the input shaft, and
wherein the range gear ratio includes,
a plurality of range gears defining a plurality of different speed ratios carried by the intermediate shaft, and configured to engage the output shaft, and
one or more third selection elements configured to selectively connect one range gear of the plurality of range gears with the intermediate shaft or the output shaft.

2. The method according to claim 1, wherein the step iv) comprises the step of progressively engaging the clutch operatively connected to the second speed gear ratio simultaneously reduce the output torque provided by the second electric machine, such that the torque provided to the at least one drive axle of work vehicle remains constant.

3. The method according to claim 2, wherein the second electric machine is operatively connected to a front axle of the work vehicle.

4. The method according to claim 3, wherein the electric transmission comprises a transmission assembly configured to be interposed between the output shaft of the second electric machine and one drive axle of the work vehicle, and is configured to provide a plurality of different speed ratios selectively engageable.

5. The method according to claim 4, wherein the transmission assembly comprises:
a first auxiliary shaft connected to the second electric machine,
a second auxiliary shaft configured to be connected to the at least one drive axle of work vehicle,
a plurality of auxiliary gears interposed between the first auxiliary shaft and the second auxiliary shaft, and
a selection element configured to selectively engage one auxiliary gear of the auxiliary gears.

6. The method according to claim 5, wherein the transmission assembly further comprises a clutch configured to be operatively interposed between the second auxiliary shaft and the at least one drive axle of the work vehicle, to selectively couple the second auxiliary shaft and the at least one drive axle of work vehicle.

7. The method according to claim 6, wherein the transmission assembly further comprises a third auxiliary shaft connected to the at least one drive axle of work vehicle by a gear and a clutch operatively interposed between the first auxiliary shaft and the third auxiliary shaft.

8. The method of claim 1, wherein the hybrid drivetrain assembly includes an electronic control unit that:
is configured to be electrically connected to, and control operation of, the first clutch, the second clutch, the first selection element, the second selection element, the one or more third selection elements, and an electric power management device, and
comprises processing circuitry including one or more processors configured to execute instructions to cause the electronic control unit to perform the steps i)-iv).

9. The method of claim 1, wherein the mechanical transmission comprises an electric transmission provided with:
a first electric machine adapted to be carried by the internal combustion engine to receive mechanical energy provided the first electric machine and transform the mechanical energy into electrical energy;
a second electric machine adapted to be connected to a drive axle of the work vehicle to impart a torque to the drive axle;
an electric power management device electrically connected to the first electric machine and the second electric machine, and
an electric energy storage system electrically connected to the first electric machine and to the second electric machine.

10. A computer-readable storage medium having stored thereon instructions that, when executed by one or more processors, cause the hybrid drivetrain assembly to operate according to the method of claim 1.

11. A hybrid drivetrain assembly of a work vehicle, the hybrid drivetrain assembly comprising:
a mechanical transmission;
an electronic control unit; and
an electric transmission,
wherein the mechanical transmission includes,
an input shaft connected to an internal combustion engine,
an output shaft connected to the at least one drive axle of the work vehicle,
a gear ratio stage and a range gear ratio stage arranged in series to each other between the input shaft and the output shaft, and
an intermediate shaft interposed between the gear ratio stage and the range gear ratio stage,
wherein the electric transmission includes,
a first electric machine adapted to be carried by the internal combustion engine to receive mechanical energy provided the first electric machine and transform the mechanical energy into electrical energy;
a second electric machine adapted to be connected to a drive axle of the work vehicle to impart a torque to the drive axle;
an electric power management device electrically connected to the first electric machine and the second electric machine, and
an electric energy storage system electrically connected to the first electric machine and to the second electric machine, and
wherein the electronic control unit is configured to control operation of the hybrid drivetrain assembly to cause the hybrid drivetrain assembly to perform the following operations:
i) transmit a torque to at least one drive axle of a work vehicle via a first speed ratio,
ii) receive a request to shift from a first speed gear ratio to a second speed gear ratio, the second speed gear ratio being different from the first speed ratio;
iii) disengage a clutch that is transmitting torque towards an output shaft and controlling a second electric machine to provide the torque to the at least one drive axle of the work vehicle, and
iv) start engaging the clutch operatively connected to the second speed gear ratio and at a same time decreasing a torque provided by the second electric machine until the torque provided to the at least one drive axle is provided through a second clutch.

12. The hybrid drivetrain assembly of claim 11, wherein,
the gear ratio stage includes,
a first shaft,
a first set of gears connecting the first shaft with the intermediate shaft and defining a plurality of different speed ratios,
a first selection element configured to selectively connect one gear of the first set of gears with the first shaft or the intermediate shaft,
a first clutch configured to selectively connect the first shaft with the input shaft,
a second shaft,
a second set of gears connecting the second shaft with the intermediate shaft defining a plurality of different speed ratios, and
a second selection element configured to selectively connect one gear of the second set of gears with the second shaft or the intermediate shaft, wherein the second clutch is configured to selectively connect the second shaft with the input shaft, and
wherein the range gear ratio includes,
a plurality of range gears defining a plurality of different speed ratios carried by the intermediate shaft, and configured to engage the output shaft, and
one or more third selection elements configured to selectively connect one range gear of the plurality of range gears with the intermediate shaft or the output shaft

13. The hybrid drivetrain assembly of claim 11, wherein the electronic control unit is configured to be electrically connected to, and control operation of, a first clutch, a second clutch, a first selection element, a second selection element, one or more third selection elements, and an electric power management device, and the electronic control unit comprises processing circuitry including one or more processors configured to execute instructions to cause the electronic control unit to perform the operations i)-iv).
